(19) United States
(12) Patent Application Publication
(10) Pub. No.: US 2009/0040141 A1
(43) Pub. Date: Feb. 12, 2009

(54) Plasma display and driving method thereof

(76) Inventor: Ji-Hoon Kim, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/081,690

(22) Filed: Apr. 18, 2008

(30) Foreign Application Priority Data
Aug. 8, 2007 (KR) 10-2007-0079579

(51) Int. Cl. G09G 3/28

(52) U.S. Cl. 345/60

(57) ABSTRACT

In a plasma display and a driving method thereof, an average grayscale value of all discharge cells are detected from an input video signal, and an auxiliary reset waveform is supplied to reset periods of all subfields when the detected average grayscale value is lower than a predetermined reference grayscale value. The reference grayscale value is established to be an average grayscale value of a video signal for selecting all of the discharge cells as turned-on cells in a subfield having a minimum weight value. Particularly, the reference grayscale value may be established to be 0 that is the same as an average grayscale value of a full-black video signal.

### CLAIM OF PRIORITY

This application makes reference to, incorporates the same herein, and claims all benefits accruing under 35 U.S.C. §119 from an application for PLASMA DISPLAY AND DRIVING METHOD THEREOF earlier filed in the Korean Intellectual Property Office on 8 Aug. 2007 and there duly assigned Serial No. 10-2007-0079579.

### BACKGROUND OF THE INVENTION

1. Field of the Invention

The present invention relates to a plasma display and a driving method thereof.

2. Description of the Related Art

A Plasma Display Panel (PDP) is a flat panel display that uses a plasma generated by a gas discharge to display characters or images. It includes, depending on its size, more than several scores to millions of pixels arranged in a matrix pattern.

One frame (1 TV field) of such a plasma display is divided into a plurality of subfields having weight values, and each subfield includes a reset period, an address period, and a sustain period.

The reset period is for initializing the state of each discharge cell so as to facilitate an addressing operation on the discharge cell, and the address period is for performing an addressing operation so as to select turned-on/turned-off cells (i.e., cells to be turned on/off). The sustain period is for causing a discharge for displaying an image on the addressed cells.

In a conventional plasma display, a main reset is performed in a first subfield SF1 of a plurality of subfields, and an auxiliary reset is performed in the remaining subfields SF2 to SFn. The main reset initializes all discharge cells, and the auxiliary reset initializes cells in which the sustain discharge has been generated in a previous subfield. In a rising period and a falling period of the main reset period, a weak discharge is generated to emit a dim light. When the main reset is performed in a full black screen, the contrast ratio is reduced since the dim light is generated by the weak discharge.

### SUMMARY OF THE INVENTION

The present invention has been made in an effort to provide a plasma display for increasing a contrast ratio in a black screen and a driving method thereof.

An exemplary embodiment of the present invention provides a method of driving a plasma display including a plurality of first and second electrodes, and a plurality of discharge cells respectively defined by the first and second electrodes. The plasma display is driven while dividing one frame into a plurality of subfields respectively having weight values. An average grayscale value displayed in all of the discharge cells are detected from an input video signal, each detected average grayscale value is compared to a predetermined reference grayscale value, and an auxiliary reset waveform that initializes a discharge cell in which an image has been displayed in a previous subfield is supplied in reset periods of the plurality of subfields in response to the detected average grayscale value being lower than the reference grayscale value.

Another exemplary embodiment of the present invention provides a method of driving a plasma display including a plurality of first and second electrodes, and a plurality of discharge cells respectively defined by the first and second electrodes. The plasma display is driven while dividing one frame into a plurality of subfields respectively having weight values. An average grayscale value displayed in all of the discharge cells are detected from an input video signal, and the plurality of first and second electrodes are respectively maintained at a reference voltage for one frame in response to the detected average grayscale value being 0, the detected average grayscale value being the same as a grayscale value of a full-black video signal.

Yet another exemplary embodiment of the present invention provides a plasma display. The plasma display is driven while dividing one frame into a plurality of subfields. The plasma display includes a plasma display panel, a driver, and a controller. The plasma display panel includes a plurality of first and second electrodes, and a plurality of discharge cells formed by the plurality of first and second electrodes. The driver supplies a main reset waveform for initializing the plurality of discharge cells in the plurality of subfields or an auxiliary reset waveform for initializing a discharge cell of the plurality of discharge cells in which an image has been displayed in a previous subfield. The controller detects an average grayscale value displayed in all of the discharge cells from an input video signal and controls the driver so that the auxiliary reset waveform is supplied in reset periods of all of the subfields in response to the detected average grayscale value being less than a predetermined reference grayscale value.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a block diagram of a plasma display according to an exemplary embodiment of the present invention.

FIG. 2 is a flowchart of the operation of the controller of FIG. 1.

FIG. 3 is a view of a method of driving the plasma display when a detected average grayscale value is lower than a reference grayscale value.

FIG. 4 includes driving waveforms of the plasma display according to the driving method of FIG. 3.

FIG. 5 is a view of the method of driving the plasma display when the detected average grayscale value is higher than the reference grayscale value.

FIG. 6 includes driving waveforms of the plasma display according to the driving method of FIG. 5.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. In addition, unless explicitly described to the contrary, the word “comprise” and variations such as “comprises” or “comprising” will be understood to imply the inclusion of stated elements but not the exclusion of any other elements.

Throughout this specification and the claims that follow, the wall charge refers to a charge that is formed on a wall (for example, a dielectric layer) of the discharge cell close to the electrodes to be stored in the electrode. Even though the wall charge is not actually in contact with the electrode, hereinafter it may be described that the wall charge is formed, accumulated, or stacked on the electrode. Further, the wall voltage refers to a potential difference generated on the wall of the discharge cell by the wall charge.

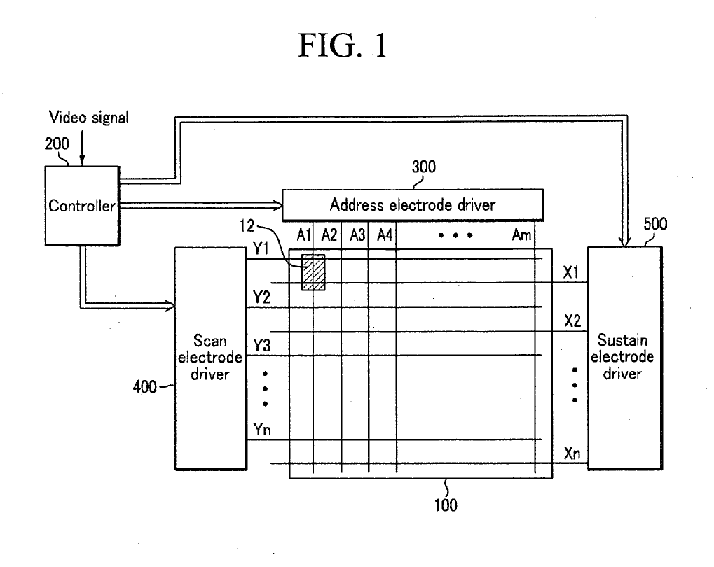

FIG. 1 is a block diagram of a plasma display according to an exemplary embodiment of the present invention.

As shown in FIG. 1, the plasma display according to the exemplary embodiment of the present invention includes a Plasma Display Panel (PDP) 100, a controller 200, an address electrode driver 300, a scan electrode driver 400, and a sustain electrode driver 500.

The PDP 100 includes a plurality of address electrodes A1 to Am extending in a column direction, and a plurality of sustain and scan electrodes X1 to Xn and Y1 to Yn extending in a row direction by pairs. In general, the sustain electrodes X1 to Xn are formed to respectively correspond to the scan electrodes Y1 to Yn. The sustain electrodes and scan electrodes perform a display operation for displaying an image in the sustain period. The scan electrodes Y1 to Yn and the sustain electrodes X1 to Xn are disposed to cross the address electrodes A1 to Am. Discharge spaces at crossing regions of the address electrodes A1 to Am and the sustain and scan electrodes X1 to Xn and Y1 to Yn form cells 12. It is to be noted that the construction of the PDP is only an example, and panels having different structures, to which a driving waveform to be described later can be supplied, may be supplied to the present invention.

The controller 200 receives an external video signal, and outputs an address electrode driving control signal, a sustain electrode driving control signal, and a scan electrode driving control signal. The controller 200 drives one frame that is divided into a plurality of subfields. Each subfield includes a reset period, an address period, and a sustain period. In the reset period, a main reset and an auxiliary reset may be selectively performed. The main reset initializes all the discharge cells, and the auxiliary reset initializes cells in which a sustain discharge has been generated in a previous subfield.

The controller 200 according to the exemplary embodiment of the present invention detects an average grayscale value of the PDP 100. When the detected average grayscale value is lower than a predetermined reference grayscale value, the controller 200 performs a control operation so that the auxiliary reset is performed in the respective reset periods of one frame.

The address electrode driver 300 receives the address electrode driving control signal from the controller 200 and supplies a display data signal to each address electrode so as to select a discharge cell to be displayed.

The scan electrode driver 400 receives the scan electrode driving control signal from the controller 200 and supplies a driving voltage to the scan electrode.

The sustain electrode driver 500 receives the sustain electrode driving control signal from the controller 200 and supplies a driving voltage to the sustain electrode.

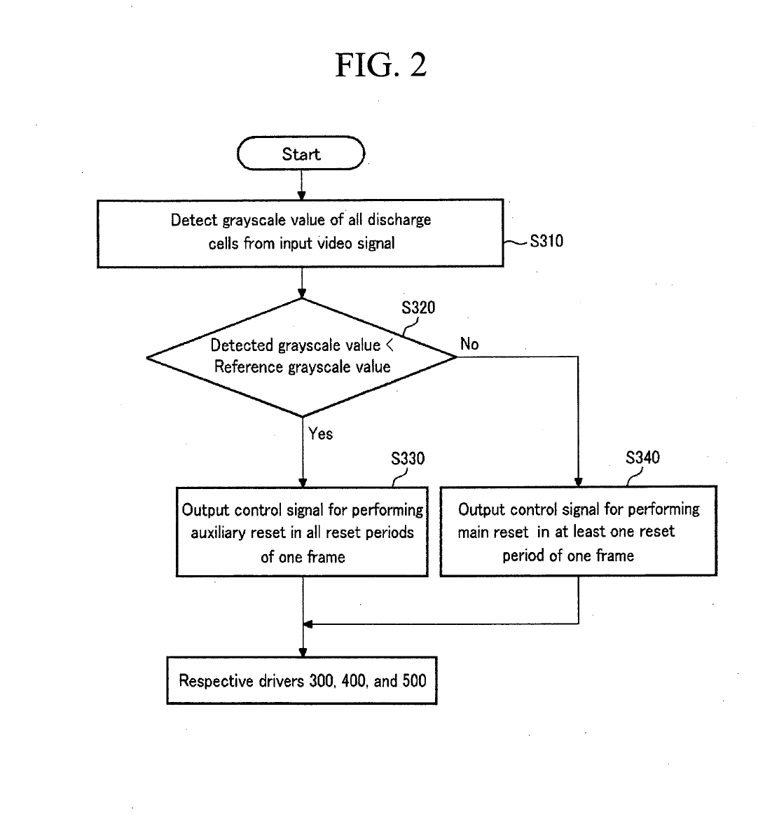

An operation of the controller of the plasma display according to the exemplary embodiment of the present invention will be described with reference to FIG. 2.

FIG. 2 is a flowchart of the operation of the controller 200 of FIG. 1.

As shown in FIG. 2, the controller 200 detects an average grayscale value displayed in all of the discharge cells from input red (R), green (G), and blue (B) video signals in step S310. The detected average grayscale value is compared to a predetermined reference grayscale value in step S320. When the detected average grayscale value is lower than the reference grayscale value, the controller 200 outputs controls signals to the respective drivers 300, 400, and 500 in step S330 so that the auxiliary reset is performed in the respective reset periods of one frame.

When the detected average grayscale value is higher than the reference grayscale value, the controller 200 outputs controls signals to the respective drivers 300, 400, and 500 so that at least one main reset is performed in the reset period of one frame in step 340.

The reference grayscale value may be established to be a average grayscale value of a video signal for selecting all of the cells as turn-on cells in a subfield having a minimum weight value. Particularly, the reference grayscale value may be established to be an average grayscale value of a full-black video signal for allowing all of the cells to have grayscales of 0. When the reference grayscale value is established to be 0, the contrast ratio is increased since a dim light is not generated in the full-black screen.

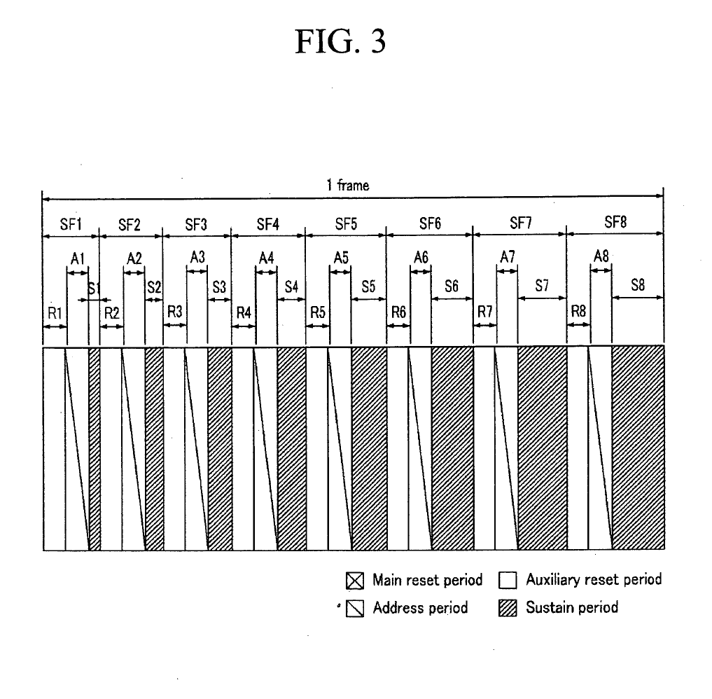

A method of driving the plasma display according to the exemplary embodiment of the present invention is described as follows with reference to FIG. 3 to FIG. 6. One frame according to the exemplary embodiment of the present invention includes a plurality of subfields. Hereinafter, it will be assumed that one frame includes eight subfields. In addition, the main reset includes a reset period including a rising period and a falling period, and the auxiliary reset includes a reset period including a falling period. For convenience of description, only a driving waveform supplied to the address electrode (hereinafter referred to as an “A electrode”), the sustain electrode (hereinafter referred to as an “X electrode”), and the scan electrode (hereinafter referred to as a “Y electrode”) that form one cell are described.

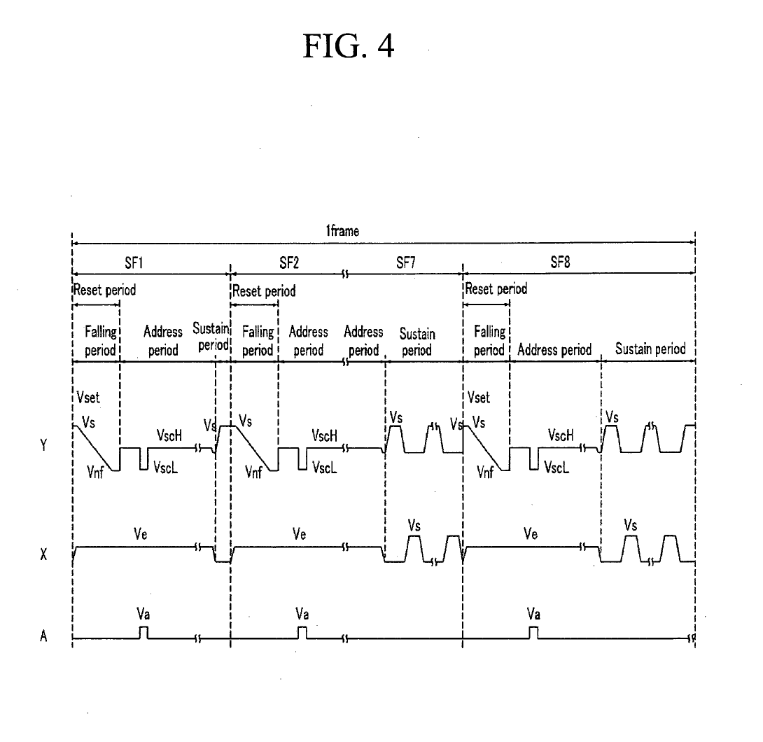

FIG. 3 is a view of the method of driving the plasma display when the detected average grayscale value is lower than the reference grayscale value, and FIG. 4 includes the driving waveforms of the plasma display according to the driving method of FIG. 3.

As shown in FIG. 3 and FIG. 4, the plasma display according to the exemplary embodiment of the present invention performs the auxiliary reset in all of the reset periods of one frame when the detected average grayscale value is lower than the reference grayscale value.

As shown in FIG. 4, in the reset periods of first to eighth subfields SF1 to SF8, while voltages at the A and X electrodes are respectively maintained at a reference voltage (it is assumed in FIG. 4 that the reference voltage is a ground voltage 0V) and a Ve voltage, that is, a voltage at the Y electrode is gradually decreased from a Vs voltage to a Vnf voltage. A weak discharge is thereby generated between the Y and X electrodes and between the Y and A electrodes while the voltage at the Y electrode decreases, and therefore, (−) wall charges formed on the Y electrode and (+) wall charges formed on the X and A electrodes are eliminated. As described above, in the first to eighth subfields SF1 to SF8 including the auxiliary reset period, the reset discharge is generated when the sustain discharge has been generated in a previous subfield, and the reset discharge is not generated when the sustain discharge has not been generated in the previous subfield. Accordingly, since the weak discharge is generated in the discharge cell in which the sustain discharge has been generated in a previous subfield when the auxiliary reset has been performed in all of the reset periods of one frame, no light is generated in the full-black screen, and the contrast ratio is increased.

In the address period of the first to eighth subfields SF1 to SF8, to select a turned-on discharge cell, while the Ve voltage is supplied to the X electrode, a scan pulse having a VscL voltage is sequentially supplied to the plurality of Y electrodes. A Va voltage is supplied to the A electrode passing through the discharge cell which is to emit light from among the plurality of discharge cells formed by the Y electrode to which the VscL voltage is supplied and by the X electrode. An address discharge is thereby generated between the A electrode to which the Va voltage is supplied and the Y electrode to which the VscL voltage is supplied and between the Y electrode to which the VscL voltage is supplied and the X electrode to which the Ve voltage is supplied. Accordingly, the (+) wall charges are formed on the Y electrode, and the (−) wall charges are formed on the A and X electrodes. A VscH voltage that is higher than the VscL voltage is supplied to the Y electrode to which the VscL voltage has not been supplied, and the reference voltage is supplied to the A electrode of the discharge cell that has not been selected.

In addition, to perform the above operation in the address period, the scan electrode driver 400 selects the Y electrode to which the scan pulse having the VscL voltage has been supplied from among the Y electrodes Y1 to Yn. For example, the Y electrode may be selected in a vertical direction in a single driving method. When one Y electrode is selected, the address electrode driver 300 selects a turn-on discharge cell among the discharge cells formed by the corresponding Y electrode. That is, the address electrode driver 300 selects a cell to which the address pulse having the Va voltage is supplied among the A electrodes.

In the sustain period of the first to eighth subfields SF1 to SF8, a sustain pulse alternately having a high level voltage (a Vs voltage in FIG. 4) and a low level voltage (the 0V voltage in FIG. 4) is supplied to the Y and X electrodes. The sustain pulse supplied to the Y electrode has an opposite phase to that supplied to the X electrode. Thereby, since the Vs voltage is supplied to the Y electrode and the 0V voltage is supplied to the X electrode, the sustain discharge is generated between the Y electrode and the X electrode. By the sustain discharge, the (−) wall charges are formed on the Y electrode and the (+) wall charges are formed on the X electrode. An operation for supplying the sustain pulse to the Y electrode and the X electrode is repeatedly performed a number of times corresponding to a weight value of the corresponding subfield. In general, the sustain pulse has a square wave having a Vs sustain interval.

As described above, according to the exemplary embodiment of the present invention, since the auxiliary reset is performed in the reset period of all the subfields when the detected average grayscale value is lower than the reference grayscale value, the weak discharge is generated only in the discharge cell in which the sustain discharge has been generated in the previous subfield. Accordingly, since no light is generated in a screen of a 0 average grayscale value, such as the full-black screen, the contrast ratio is excellent.

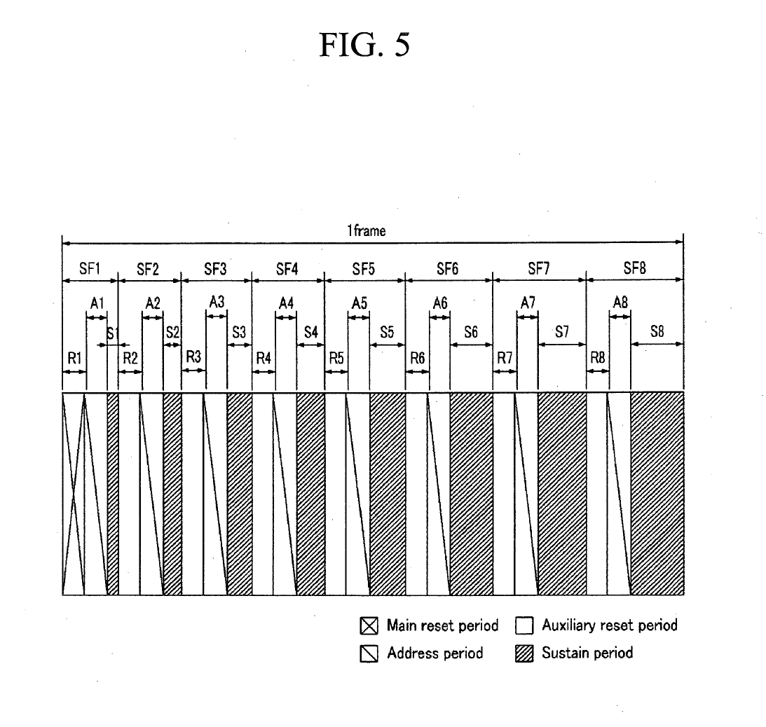

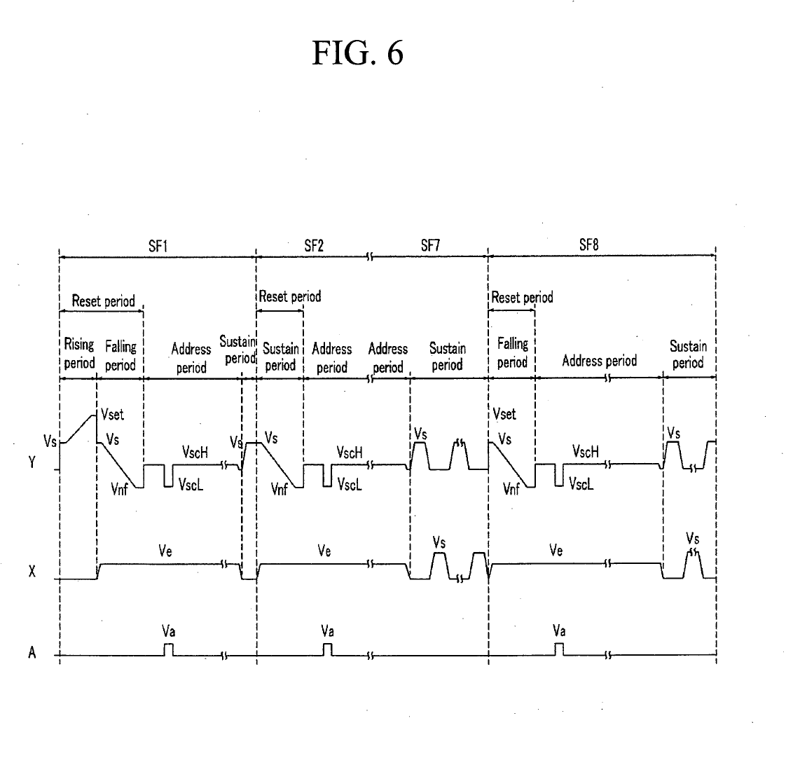

A case where the detected average grayscale value is lower than the reference grayscale value has been described. Hereinafter, a case where the detected average grayscale value is higher than the reference grayscale value is described with reference to FIG. 5 and FIG. 6.

FIG. 5 is a view of a method of driving the plasma display when the detected average grayscale value is higher than the reference grayscale value, and FIG. 6 includes driving waveforms of the plasma display according to the driving method of FIG. 5.

As shown in FIG. 5 and FIG. 6, the plasma display according to the exemplary embodiment of the present invention performs the main reset in the reset period of at lease one subfield in one frame when the detected average grayscale value is higher than the reference grayscale value. For better understanding and ease of description, it is assumed that the main reset is performed in the reset period of the first subfield. The driving method shown in FIG. 5 is the same as that shown in FIG. 3 except that the main reset is performed in the reset period of the first subfield.

Accordingly, as shown in FIG. 6, in the rising period of the reset period of the first subfield SF1, while the voltages at the X and A electrodes are maintained at the reference voltage, the voltage at the Y electrode is gradually increased from the Vs voltage to a Vset voltage. As described, while the voltage at the Y electrode increases, since the weak discharge is generated between the Y and X electrodes and between the Y and A electrodes, the (−) wall charges are formed on the Y electrode and the (+) wall charges are formed on the X and A electrodes.

In the falling period of the reset period of the first subfield SF1, while the voltages at the A and X electrodes are respectively maintained at the reference voltage and the Ve voltage, the voltage at the Y electrode is gradually decreased from the Vs voltage to a Vnf voltage. Since the weak discharge is generated between the Y and X electrodes and between the Y and A electrodes while the voltage at the Y electrode decreases, the (−) wall charges formed on the Y electrode and (+) wall charges formed on the X and A electrodes are eliminated. In generally, a voltage of (Vnf-Ve) is set to close to a discharge firing voltage Vfxy between the Y and X electrodes. Since a wall voltage between the Y and X electrodes becomes close to the 0V voltage, a cell in which no address discharge is generated in the address period is prevented from being misfired in the sustain period. Since all the discharge cells are initialized when the main reset is performed in the reset period of the first subfield SF1, priming particles are sufficiently formed in the discharge cell 12.

According to another exemplary embodiment of the present invention, when the full-black video signal of the 0 average grayscale value is input, the controller 200 supplies the reference voltage 0V to the respective electrodes in the reset period, the address period, and the sustain period. Since no discharge is generated in the full-black screen, the contrast ratio is excellent.

As described, according to the exemplary embodiment of the present invention, since the auxiliary reset is performed in all of the reset periods of one frame when an average grayscale value of an input image is lower than a predetermined reference grayscale value, a dim light is generated or no light is generated by the reset discharge in a screen of a low grayscale, such as the full-black screen, and therefore the contrast ratio is excellent.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

What is claimed is:

1. A method of driving a plasma display including a plurality of first and second electrodes, and a plurality of discharge cells respectively defined by the first and second electrodes, the driving method comprising:
dividing one frame into a plurality of subfields respectively having weight values;
detecting an average grayscale value displayed in all of the discharge cells from an input video signal;
comparing the detected average grayscale value to a predetermined reference grayscale value; and
supplying an auxiliary reset waveform in reset periods of the plurality of subfields when the detected average grayscale value is lower than the reference grayscale value, the auxiliary reset waveform initializing a discharge cell in which an image has been displayed in a previous subfield.

2. The driving method of claim 1, further comprising:
supplying a main reset waveform to initialize all of the discharge cells in at least one reset period among the plurality of subfields in response to the detected average grayscale value being higher than the reference grayscale value.

3. The driving method of claim 1, further comprising setting the reference grayscale value to an average grayscale value of a video signal to select all of the discharge cells to be turned-on cells in a subfield having a minimum weight value.

4. The driving method of claim 1, further comprising setting the reference grayscale value equal to 0, the reference grayscale value being equal to an average grayscale value of a full-black video signal.

5. The driving method of claim 1, further comprising setting the auxiliary reset waveform to gradually decrease a voltage at the plurality of second electrodes from a second voltage that is higher than a first voltage to a third voltage while the first voltage is being supplied to the plurality of first electrodes.

6. The driving method of claim 2, further comprising setting the main reset waveform to gradually decrease a voltage at the plurality of second electrodes from a fifth voltage that is lower than a third voltage to a sixth voltage while a fourth voltage that is higher than the first voltage is being supplied to the plurality of first electrodes after the first voltage has been supplied to the plurality of first electrodes and the voltage at the plurality of second electrodes is gradually increased from a second voltage to a third voltage.

7. A method of driving a plasma display including a plurality of first and second electrodes, and a plurality of discharge cells respectively defined by the first and second electrodes, the driving method comprising:
dividing one frame into a plurality of subfields respectively having weight values;
detecting an average grayscale value displayed in all of the discharge cells from an input video signal; and
respectively maintaining the plurality of first and second electrodes at a reference voltage for one frame in response to the detected average grayscale value being 0, the reference value being equal to an average grayscale value of a full-black video signal.

8. The driving method of claim 7, wherein the reference voltage is equal to a 0V voltage.

9. A plasma display driven while dividing one frame into a plurality of subfields, the plasma display comprising:
a plasma display panel including a plurality of first and second electrodes, and a plurality of discharge cells formed by the plurality of first and second electrodes;
a driver to supply a main reset waveform to initialize the plurality of discharge cells in the plurality of subfields or to supply an auxiliary reset waveform to initialize a discharge cell of the plurality of discharge cells in which an image has been displayed in a previous subfield; and
a controller to detect an average grayscale value displayed in all of the discharge cells from an input video signal and to control the driver to supply the auxiliary reset waveform in reset periods of all of the subfields in response to the detected average grayscale value being less than a predetermined reference grayscale value.

10. The plasma display of claim 9, wherein the controller controls the driver to supply the main reset waveform in at least one subfield of the plurality of subfields in response to the detected average grayscale value being greater than the predetermined reference grayscale value.

11. The plasma display of claim 9, wherein the reference grayscale value is equal to an average grayscale value of a video signal to select all of the discharge cells as turned-on cells in a subfield having a minimum weight value.

12. The plasma display of claim 9, wherein the reference grayscale value is equal to 0, the reference grayscale value being same as an average grayscale value of a full-black video signal.

13. The plasma display of claim 9, wherein the main reset waveform gradually decreases a voltage at the plurality of second electrodes from a fifth voltage that is lower than a third voltage to a sixth voltage while a fourth voltage that is higher than the first voltage is being supplied to the plurality of first electrodes after the first voltage has been supplied to the plurality of first electrodes and the voltage at the plurality of second electrodes is gradually increased from a second voltage to a third voltage.

14. The plasma display of claim 9, wherein the auxiliary reset waveform gradually decreases a voltage at the plurality of second electrodes from a second voltage to a third voltage while the first voltage is being supplied to the plurality of first electrodes.
